(19) United States
(12) Patent Application Publication
(10) Pub. No.: US 2018/0041699 A1
(43) Pub. Date: Feb. 8, 2018

(54) IMAGE DISPLAY SYSTEM

(71) Applicant: CANON KABUSHIKI KAISHA, Tokyo (JP)

(72) Inventors: Masakazu Tohara, Komae-shi (JP); Kazutaka Inoguchi, Tokyo (JP); Takeyoshi Saiga, Tokyo (JP); Nobuyuki Saito, Kawasaki-shi (JP); Kohki Abiko, Tokyo (JP); Yu Okano, Tokyo (JP); Toshiki Ishino, Hiratsuka-shi (JP)

(21) Appl. No.: 15/664,194

(22) Filed: Jul. 31, 2017

(30) Foreign Application Priority Data
Aug. 4, 2016 (JP) 2016-153668

(51) Int. Cl. H04N 5/232; G06T 11/60; G06T 3/40

(52) U.S. Cl. CPC H04N 5/23238; G06T 3/4038; G06T 11/60; G02B 27/017

(57) ABSTRACT

The image display system includes a first image producer producing a first left-eye display image using a left-eye original image that is a left-eye captured image or a left-eye processed image produced therefrom, and producing a first right-eye display image using a right-eye original image that is a right-eye captured image or a right-eye processed image produced therefrom. A first image display unit allows left and right eyes of a viewer to view the first left-eye and right-eye display images. The first image producer produces the first left-eye and right-eye display images each corresponding to an image of a partial area of the original image. A second image producer produces, using at least one of the left-eye and right-eye original images, a second display image corresponding to an image of an area including the above partial area and being wider than that partial area.

### BACKGROUND OF THE INVENTION

### Field of the Invention

The present invention relates to an image display system including an image display apparatus such as a video see-through head-mounted display (HMD) that is mounted on a head of a viewer and allows the viewer to view left-eye and right-eye captured images acquired by image capturing through his/her left and right eyes.

### Description of the Related Art

The video see-through HMD displays on a display element a display image produced by superimposing a CD (Computer Graphic) image on a captured image acquired by image capturing of a real object and introduces light from the display element such as an LCD to eyes of a viewer through a display optical system. In such a video see-through HMD, from reasons such as facilitating positional alignment between the captured image and the display image, it is desirable that an angle of view for image capturing (hereinafter referred to as “an image-capturing angle of view”) be wider than an angle of view for display (hereinafter referred to as “a display angle of view”) by the display element. Furthermore, it is desirable that, in order to enable another viewer not mounting the HMD to view the display image, the display image can be output to an external display apparatus.

Such HMDs are disclosed in Japanese Laid-Open Nos. 2004-258123 and 2006-041795. The HMD disclosed in Japanese Laid-Open No. 2004-258123 switches, depending on a use status of the HMD, images to be output to an external display apparatus. The HMD disclosed in Japanese Laid-Open No. 2006-041795 includes an image corrector that performs a distortion correction and a gamma correction on an image output to an external display apparatus.

However, outputting the display image to the external display apparatus without change when the display angle of view is narrower than the image-capturing angle of view only enables a viewer viewing the external display apparatus to view a display image whose display angle of view is narrow. The viewer viewing the external display apparatus sometimes wants to view an image whose display angle of view is wider than that of the viewer mounting the HMD. The HMDs disclosed in Japanese Laid-Open Nos. 2004-258123 and 2006-041795 can output, to the external display apparatus, only a display image whose display angle of view is narrower than the image-capturing angle of view.

### SUMMARY OF THE INVENTION

The present invention provides an image display system using a video see-through HMD whose image-capturing angle of view is wider than its display angle of view; the system is capable of producing a display image outputtable to an external display apparatus and corresponding to a wider display angle of view than that of an image displayed in the HMD.

The present invention provides as an aspect thereof an image display system including a left-eye image capturer and a right-eye image capturer respectively configured to acquire, by image capturing, a left-eye captured image and a right-eye captured image, a first image producer configured to produce a first left-eye display image using a left-eye original image that is the left-eye captured image or a left-eye processed image produced by image processing performed on the left-eye captured image, and produce a first right-eye display image using a right-eye original image that is the right-eye captured image or a right-eye processed image produced by the image processing performed on the right-eye captured image, and a first image display unit configured to allow a left eye and a right eye of a first viewer to view the first left-eye display image and the first right-eye display image. The first image producer is configured to produce the first left-eye display image corresponding to an image of a partial area of the left-eye original image and produce the first right-eye display image corresponding to an image of a partial area of the right-eye original image. The system further includes a second image producer configured to produce, using at least one of the left-eye original image and the right-eye original image, a second display image corresponding to an image of an area including the partial area of the at least one of the left-eye and right-eye original images and being wider than that partial area.

The present invention provides as another aspect thereof a non-transitory storage medium storing a computer program for causing a computer of the image display system to execute a display process. The image display system includes a left-eye image capturer and a right-eye image capturer respectively configured to acquire, by image capturing, a left-eye captured image and a right-eye captured image, and a first image display unit configured to allow a left eye and a right eye of a first viewer to view a first left-eye display image and a first right-eye display image. The display process includes a process for producing the first left-eye display image using a left-eye original image that is the left-eye captured image or a left-eye processed image produced by image processing performed on the left-eye captured image, and producing the first right-eye display image using a right-eye original image that is the right-eye captured image or a right-eye processed image produced by image processing performed on the right-eye captured image, the first left-eye display image corresponding to an image of a partial area of the left-eye original image, the first right-eye display image corresponding to an image of a partial area of the right-eye original image, and a process for producing, using at least one of the left-eye original image and the right-eye original image, a second display image corresponding to an image of an area including the partial area of the at least one of the left-eye and right-eye original images and being wider than that partial area.

Further features of the present invention will become apparent from the following description of exemplary embodiments with reference to the attached drawings.

### BRIEF DESCRIPTION OF THE DRAWINGS

FIG. 1 illustrates a configuration of a video see-through HMD system that is Embodiment 1 of the present invention.

FIG. 2 illustrates a configuration of an HMD in Embodiment 1.

FIGS. 3A to 3C respectively illustrate a captured image, a wide-angle monitoring display image, and a left-eye display image in the HMD system of Embodiment 1.

FIG. 4 illustrates a configuration of a video see-through HMD system that is Embodiment 2 of the present invention.

FIG. 5 illustrates a configuration of an HMD in Embodiment 2.

FIG. 6 illustrates a viewable image viewable by left and right eyes through the HMD in Embodiment 2.

FIGS. 7A to 7C respectively illustrate a captured image, a wide-angle monitoring display image, and a left-eye display image in the HMD system of Embodiment 2.

FIGS. 8A to 8C respectively illustrate another captured image, another wide-angle monitoring display image, and another left-eye display image in the HMD system of Embodiment 2.

FIG. 9 illustrates a monitoring combined display image produced by combining left-eye and right-eye display images in the HMD system of Embodiment 2.

FIG. 10 is a flowchart of a process performed by a PC board in Embodiment 1.

### DESCRIPTION OF THE EMBODIMENTS

Exemplary embodiments of the present invention will hereinafter be described with reference to the accompanying drawings.

### Embodiment 1

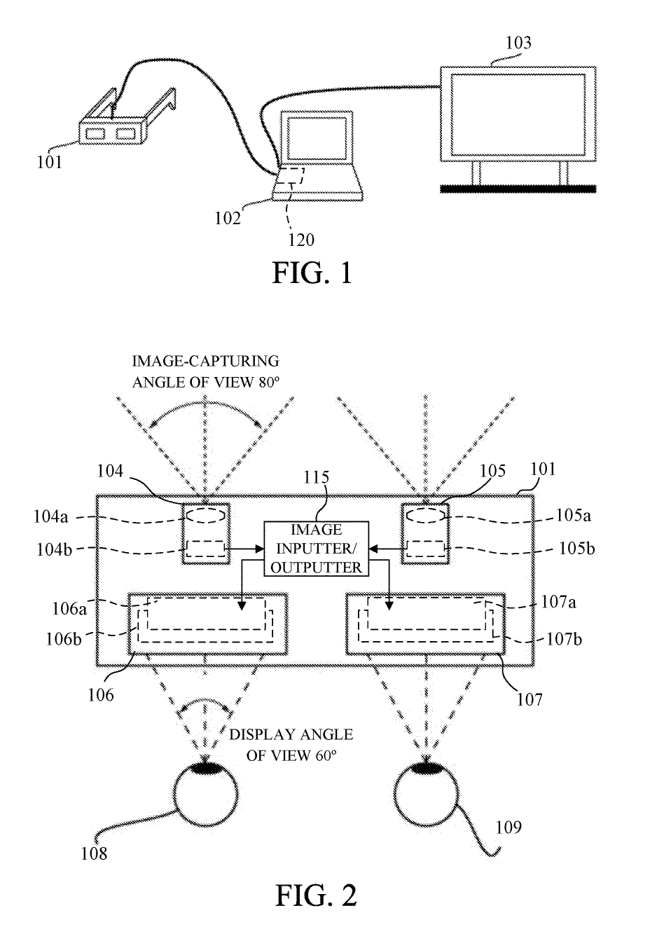

FIG. 1 illustrates a configuration of a video see-through HMD (Head-Mounted Display) system as an image display system that is a first embodiment (Embodiment 1) of the present invention. The system includes a video see-through HMD 101 as an image display apparatus, a personal computer (hereinafter referred to as “a PC”) 102, and an external monitor 103 as a second image display unit. The HMD 101 is mounted on a head of a first viewer (not illustrated and hereinafter referred to as “an HMD viewer”). The HMD 101 displays (enlarged virtual images of) a left-eye display image and a right-eye display image, which will be described later, respectively to a left eye and a right eye of the HMD viewer.

The PC 102 is provided with a PC board 120 installed therein and serving as an image processing apparatus including a first image producer and a second image producer. The PC board 120 is part of the HMD system.

The PC board 120 as an image processing computer performs the following processes according to an image processing program as a computer program.

The PC board 120 performs image processing on a left-eye captured image and a right-eye captured image, which will be described later, to produce a left-eye original image as a left-eye processed image and a right-eye original image as a right-eye processed image. Furthermore, the PC board 120 produces a first left-eye display image (hereinafter simply referred to as “a left-eye display image”) using the left-eye original image, and produces a first right-eye display image (hereinafter simply referred to as “a right-eye display image”) using the right-eye original image. The PC board 120 outputs these left-eye and right-eye display images to the HMD 101. Moreover, the PC board 120 produces, using at least one of the left-eye and right-eye original images, a wide-angle monitoring display image (second display image) described later to output the wide-angle monitoring display image to the external monitor 103. The PC board 120 serves also as an image outputter.

The external monitor 103 displays the wide-angle monitoring display image input from the PC board 120 to allow one or more second viewers different from the HMD viewer (the second viewer is hereinafter referred to as “a monitoring viewer”) to view the wide-angle monitoring display image.

FIG. 2 illustrates a configuration of the HMD 101. The HMD 101 includes a left-eye image capturer 104, a right-eye image capturer 105, a left-eye display unit 106, and a right-eye display unit 107.

The left-eye display unit 106 and the right-eye display unit 107 constitute a first image display unit. In addition, the HMD 101 includes an image inputter/outputter 115.

The video see-through HMD 101 acquires, by image capturing of a real world by the left-eye image capturer 104 and the right-eye image capturer 105, the left-eye captured image and the right-eye captured image. The left-eye image capturer 104 includes a left-eye image-capturing optical system 104a that forms an object image, and a left-eye image sensor 104b that photoelectrically converts (captures) the object image. The right-eye image capturer 105 includes a right-eye image-capturing optical system 105a that forms an object image, and a right-eye image sensor 105b that photoelectrically converts (captures) the object image.

The image inputter/outputter 115 outputs the left-eye and right-eye captured images acquired respectively through the left-eye and right-eye image capturers 104 and 105 to the PC board 120 installed in the PC 102.

FIG. 10 is a flowchart illustrating a display process executed by the PC board 120 according to the image display program. At step S301, the PC board 120 acquires the left-eye and right-eye captured images output from the image inputter/outputter 115.

Next at step S302, the PC board 120 performs, on the left-eye captured image and the right-eye captured image, image processing for superimposing thereon a CG (Computer Graphic) image as another image than the left-eye and right-eye captured images to produce the left-eye original image as the left-eye processed image and the right-eye original image as the right-eye processed image. Then, at step S303, the PC board 120 clips, from the left-eye original image and the right-eye original image, images of partial areas thereof to produce the left-eye display image and the right-eye display image. The PC board 120 outputs the left-eye and right-eye display images to the image inputter/outputter 115.

The left-eye display unit 106 includes a left-eye display element 106a that displays the left-eye display image input from the image inputter/outputter 115, and a left-eye display optical system 106b that introduces light from the left-eye display element 106a (that is, the left-eye display image) to a left eye 108 of the HMD viewer placed at a position of a left exit pupil of the left-eye display optical system 106b. The right-eye display unit 107 includes a right-eye display element 107a that displays the right-eye display image input from the image inputter/outputter 115, and a right-eye display optical system 107b that introduces light from the right-eye display element 107a (that is, the right-eye display image) to a right eye 109 of the HMD viewer placed at a position of a right exit pupil of the right-eye display optical system 107b.

In this embodiment, the left-eye and right-eye image capturers 104 and 105 each have an image-capturing angle of view of 80° in a horizontal direction, which is wider than 60° that is a display angle of view of each of the left-eye and right-eye display units 106 and 107.

The wider image-capturing angle of view of each image capturer than the display angle of view of each display unit enables producing the display image to be displayed by each display unit by clipping the display image (partial area) from the captured image acquired by each image capturer while adjusting a clipped position of partial area. This makes it possible to easily adjust alignment of optical axes of the image capturer and the display unit corresponding thereto. In addition, the wider image-capturing angle of view enables, when the captured image is used in measurement of an object distance in the real world and in feature point detection for the CG image superimposition, performing the object distance measurement and the feature point detection even for an object located near an edge of the display angle of view of the display unit with high accuracy.

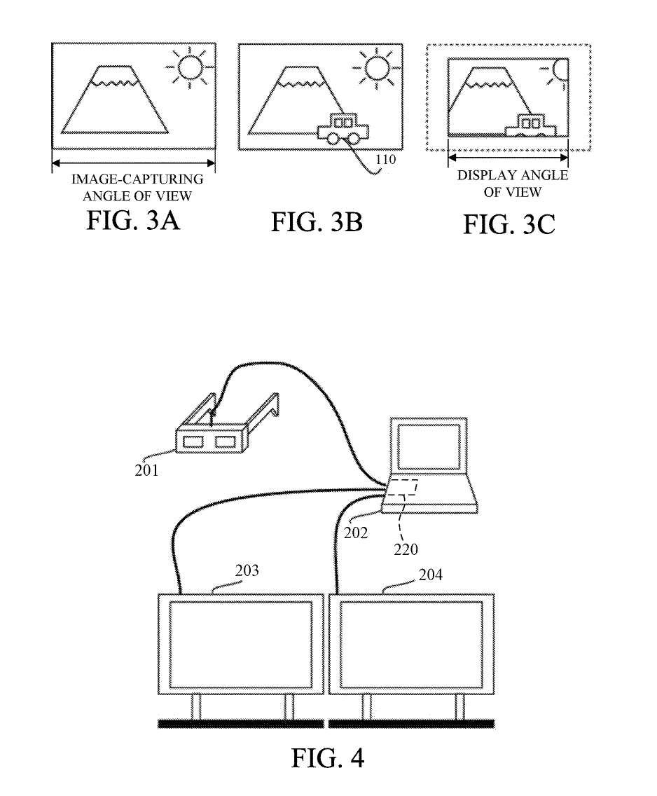

FIG. 3A illustrates an example of the captured image acquired by the left-eye image capturer 104 with the above-described image-capturing angle of view. FIG. 3B illustrates an example of the left-eye original image as the left-eye processed image that is produced by the PC board 120 superimposing the CG image 110 on the left-eye captured image.

FIG. 3C illustrates an example of the left-eye display image corresponding to an image of a partial area of the left-eye original image. As illustrated in FIG. 3C, the PC board 120 clips, from the left-eye original image illustrated in FIG. 3B, the partial area corresponding to the display angle of view of the left-eye display unit 106 to produce the left-eye display image.

Furthermore, at step S304, the PC board 120 outputs, to the external monitor 103, the left-eye original image illustrated in FIG. 3B as the wide-angle monitoring display image.

At this step, the PC board 120 serving as a selector can select whether to output the left-eye original image illustrated in FIG. 3B as the wide-angle monitoring display image to the external monitor 103 or to output thereto the left-eye display image illustrated in FIG. 3C.

The left-eye original image as the wide-angle monitoring display image can display a wider area than the left-eye display image. In response to a selection input by the monitoring viewer desired to view the same image as that viewed by the HMD viewer, the PC board 120 selects the left-eye display image illustrated in FIG. 3C. On the other hand, in response to a selection input by the monitoring viewer desired to view an image corresponding to a wider angle of view than that of the left-eye display image viewed by the HMD viewer, the PC board 120 selects the left-eye original image (wide-angle monitoring display image) illustrated in FIG. 3B.

The description made with reference to FIGS. 3A to 3C also applies to the right-eye captured image, the right-eye original image and the right-eye display image. That is, the PC board 120 superimposes the CG image 110 on the right-eye captured image to produce the right-eye original image as the right-eye processed image. Then, the PC board 120 clips, from the right-eye original image, a partial area corresponding to the display angle of view of the right-eye display unit 107 to produce the right-eye display image. Furthermore, the PC board 120 can select whether to output the right-eye original image as the wide-angle monitoring display image to the external monitor 103 or to output thereto the right-eye display image.

Moreover, when two external monitors 103 are provided, the PC board 120 may cause one of the external monitors 103 to display the left-eye display image produced from the left-eye original image, and cause the other one of the external monitors 103 to display the right-eye display image produced from the right-eye original image. Alternatively, the PC board 120 may cause one of the external monitors 103 to display the left-eye original image (wide-angle monitoring display image) illustrated in FIG. 3B, whose display angle of view is wide, and cause the other one of the external monitors 103 to display the left-eye display image illustrated in FIG. 3C.

In addition, when an aspect ratio of the captured image (for example, the left-eye captured image) is different from that of the external monitor 103, the PC board 120 may clip, from the left-eye captured image, a partial area corresponding to the aspect ratio of the external monitor 103 to produce the left-eye display image.

Alternatively, the PC board 120 may scale the clipped left-eye display image so as to correspond to the aspect ratio of the external monitor 103.

Furthermore, the PC board 120 may perform a display process different from that illustrated in FIG. 10 in the following order: acquisition of the captured image; clipping of the wide-angle monitoring display image; superimposition of the CG image on the wide-angle monitoring display image; and clipping of the display image from the CG superimposed image. This is because, since superimposition of the CG image and processing and transmission of the CG superimposed image increase a load of the PC board 120, it is desirable that the image on which the CG image is superimposed be image data as light (small) as possible.

### Embodiment 2

FIG. 4 illustrates a configuration of a video see-through HMD as an image display system that is a second embodiment (Embodiment 2) of the present invention. The system includes a video see-through HMD 201 as an image display apparatus, a personal computer (PCs) 202, and two external monitors 203 and 204 as second image display units. The HMD 201 is mounted on a head of an HMD viewer and displays (enlarged virtual images of) a left-eye display image and a right-eye display image, which will be described later, respectively to a left eye and a right eye of the HMD viewer.

The PC 202 is provided with a PC board 220 installed therein and serving as an image processing apparatus including a first image producer and a second image producer. The PC board 120 is part of the HMD system. The PC board 220 as an image processing computer performs the following processes according to an image processing program as a computer program.

The PC board 220 performs image processing on a left-eye captured image and a right-eye captured image, which will be described later, to produce a left-eye original image as a left-eye processed image and a right-eye original image as a right-eye processed image. Furthermore, the PC board 220 produces a first left-eye display image (hereinafter simply referred to as “a left-eye display image”) using the left-eye original image, and produces a first right-eye display image (hereinafter simply referred to as “a right-eye display image”) using the right-eye original image. The PC board 220 outputs these left-eye and right-eye display images to the HMD 201. Moreover, the PC board 220 produces, using at least one of the left-eye and right-eye original images, a wide-angle monitoring display image (second display image) described later to output any of the wide-angle monitoring display image, the left-eye display image and the right-eye display image to the external monitors 203 and 204. The PC board 220 serves also as an image outputter.

The external monitors 203 and 204 display any of the wide-angle monitoring display image, the left-eye display image and the right-eye display image input from the PC board 220 to allow one or more monitoring viewers different from the HMD viewer to view the displayed images.

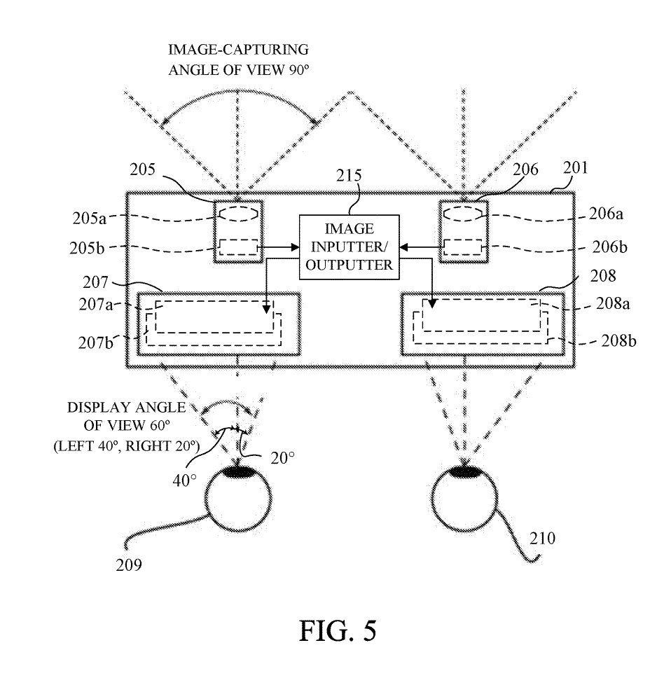

FIG. 5 illustrates a configuration of the HMD 201. The HMD 201 includes a left-eye image capturer 205, a right-eye image capturer 206, a left-eye display unit 207, and a right-eye display unit 208.

The left-eye display unit 207 and the right-eye display unit 208 constitute a first image display unit. In addition, the HMD 201 includes an image inputter/outputter 215.

The video see-through HMD 201 acquires, by image capturing of a real world by the left-eye image capturer 205 and the right-eye image capturer 206, the left-eye captured image and the right-eye captured image. The left-eye image capturer 205 includes a left-eye image-capturing optical system 205a that forms an object image, and a left-eye image sensor 205b that photoelectrically converts (captures) the object image. The right-eye image capturer 206 includes a right-eye image-capturing optical system 206a that forms an object image, and a right-eye image sensor 206b that photoelectrically converts (captures) the object image.

The image inputter/outputter 215 outputs the left-eye and right-eye captured images acquired through the left-eye and right-eye image capturers 205 and 206 to the PC board 220 installed in the PC 202.

The PC board 220 performs, on the left-eye captured image and the right-eye captured image, image processing for superimposing thereon a CG image as another image than the left-eye and right-eye captured images to produce the left-eye original image as the left-eye processed image and the right-eye original image as the right-eye processed image. The PC board 220 further produces, using the left-eye original image and the right-eye original image, the left-eye display image and the right-eye display image corresponding to images of partial areas of the left-eye original image and the right-eye original image. The PC board 120 outputs the left-eye and right-eye display images to the image inputter/outputter 215.

The left-eye display unit 207 includes a left-eye display element 207a that displays the left-eye display image input from the image inputter/outputter 215, and a left-eye display optical system 207b that introduces light from the left-eye display element 207a (that is, the left-eye display image) to a left eye 209 of the HMD viewer placed at a position of a left exit pupil of the left-eye display optical system 207b. The right-eye display unit 208 includes a right-eye display element 208a that displays the right-eye display image input from the image inputter/outputter 215, and a right-eye display optical system 208b that introduces light from the right-eye display element 208a (that is, the right-eye display image) to a right eye 210 of the HMD viewer placed at a position of a right exit pupil of the right-eye display optical system 208b.

In this embodiment, the left-eye and right-eye image capturers 205 and 206 each have an image-capturing angle of view of 90° in a horizontal direction, which is wider than 80° that is a display angle of view of each of the left-eye and right-eye display units 207 and 208.

As described in Embodiment 1, the wider image-capturing angle of view of each image capturer than the display angle of view of each display unit enables easily adjusting alignment of optical axes of the image capturer and the display unit corresponding thereto. In addition, the wider image-capturing angle of view enables performing the object distance measurement and the feature point detection even for the object located near the edge of the display angle of view of the display unit with high accuracy.

In this embodiment, the horizontal display angle of view of the left-eye display unit 207 includes, across a visual axis of the left eye 209 of the HMD viewer, a left side angle of view of 40° and a right side angle of view of 20°. That is, the left side angle of view (in other words, an outside angle of view) of the left-eye display unit 207 is larger than the right side angle of view (in other words, an inside angle of view) thereof. On the other hand, the horizontal display angle of view of the right-eye display unit 208 includes, across a visual axis of the right eye 210 of the HMD viewer, a right side angle of view of 40° and a left side angle of view of 20°. That is, the right side angle of view (in other words, an outside angle of view) of the right-eye display unit 208 is larger than the left side angle of view (in other words, an inside angle of view) thereof. Such setting of the display angle of views enables, though the horizontal display angle of view of each of the left-eye and right-eye display units 207 and 208 is 60°, providing a combined horizontal display angle of view viewable by the HMD viewer through the left and right eyes 209 and 210 to 80°. That is, the setting increases the horizontal display angle of view.

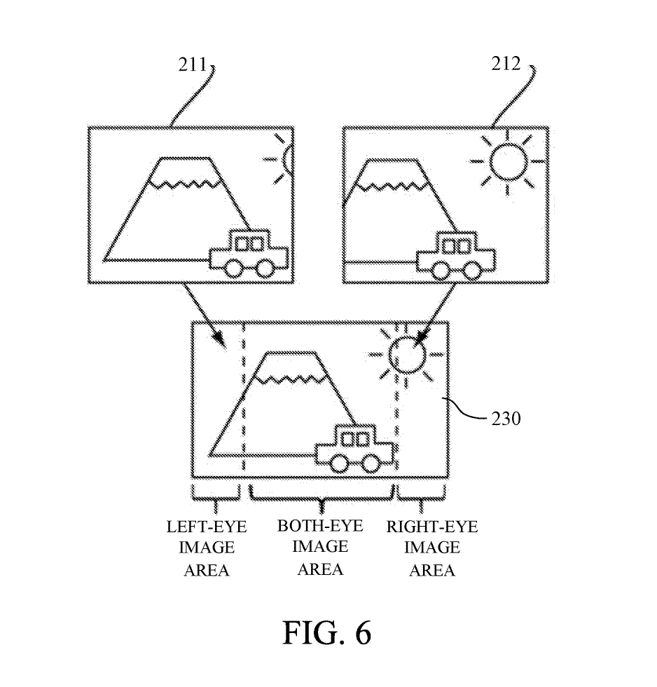

FIG. 6 illustrates an example of a combined viewable image 230 that is viewed by the HMD viewer through the left and right eyes (209 and 210) when a left-eye display image 211 is displayed on the left-eye display element 207a of the left-eye display unit 207 and a right-eye display image 212 is displayed on the right-eye display element 208a of the right-eye display unit 208. A left-eye viewable image corresponding to the left-eye display image 211 and a right-eye viewable image corresponding to the right-eye display image 212 are fused in a brain of the HMD viewer, and thereby the HMD viewer can view the combined (fused) viewable image 230. A left-eye image area that is a left side area of the left-eye display image 211 is viewed only through the left eye, and a right-eye image area that is a right side area of the right-eye display image 212 is viewed only through the right eye. On the other hand, a right-eye image area that is a right side area of the left-eye display image 211 and a left-eye image area that is a left side area of the right-eye display image 212 are viewed overlapped with each other as a both-eye image area through the left and right eyes.

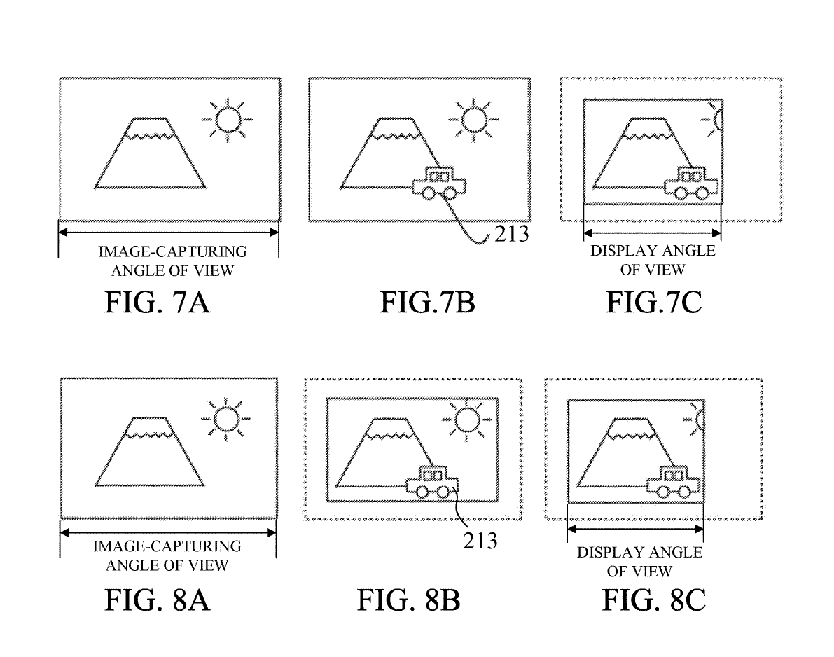

FIG. 7A illustrates an example of the left-eye captured image acquired through image capturing by the left-eye image capturer 205 with the above-described image-capturing angle of view. FIG. 7B illustrates an example of the left-eye original image as the left-eye processed image produced by the PC board 220 that superimposes a CG image 213 on the left-eye captured image. FIG. 7C illustrates an example of the left-eye display image corresponding to an image of a partial area of the left-eye original image. As illustrated in FIG. 7C, the PC board 120 clips, from the left-eye original image illustrated in FIG. 7B, the partial area corresponding to the display angle of view of the left-eye display unit 207 to produce the left-eye display image.

Furthermore, the PC board 220 serving as a selector can select whether to output the left-eye original image illustrated in FIG. 7B as the wide-angle monitoring display image to the external monitor 103 or to output thereto the left-eye display image illustrated in FIG. 7C.

The left-eye original image as the wide-angle monitoring display image can display a wider area than the left-eye display image.

In response to a selection input by the monitoring viewer desired to view the same image as that viewed by the HMD viewer, the PC board 220 selects the left-eye display image illustrated in FIG. 7C. On the other hand, in response to a selection input by the monitoring viewer desired to view an image corresponding to a wider angle of view than that of the left-eye display image viewed by the HMD viewer, the PC board 220 selects the left-eye original image (wide-angle monitoring display image) illustrated in FIG. 7B.

The description made with reference to FIGS. 7A to 7C also applies to the right-eye captured image, the right-eye original image and the right-eye display image. That is, the PC board 220 superimposes the CG image 213 on the right-eye captured image to produce the right-eye original image as the left-eye processed image. Then, the PC board 220 clips, from the right-eye original image, a partial area corresponding to the display angle of view of the right-eye display unit 208 to produce the right-eye display image. Furthermore, the PC board 220 can select whether to output the right-eye original image as the wide-angle monitoring display image to the external monitor 204 or to output thereto the right-eye display image.

The PC board 220 may clip, from a left-eye captured image illustrated in FIG. 8A, a partial area corresponding to the combined horizontal display angle of view of 80° viewable through the light and right eyes to produce a partial area image illustrated in FIG. 8B, and superimpose the CG image 213 on the partial area image. Thereby, a left-eye original image whose angle of view is smaller than that of the left-eye captured image can be produced. In this case, the PC board 220 may clip, from the left-eye original image illustrated in FIG. 8B, a partial area corresponding to the display angle of view of the left-eye display unit 207 to produce the left-eye display image. This process enables reducing a size of the left-eye original image on which the image processing for the superimposition of the CG image is performed, thereby enabling reducing loads in the image processing and in CG superimposed image transmission. Furthermore, displaying the left-eye original image illustrated in FIG. 8B on the external monitor 203 enables the monitoring viewer to also view the fused viewable image whose horizontal display angle of view is 80° and that is viewed by the HMD viewer.

The description made with reference to FIGS. 8A to 8C also applies to the right-eye captured image, the right-eye original image and the right-eye display image. That is, the PC board 220 may clip, from the right-eye captured image, a partial area corresponding to the combined horizontal display angle of view of 80° viewable through the left and right eyes to produce a partial area image, and superimpose the CG image 213 on the partial area image. The PC board 220 may clip, from the right-eye original image, a partial area corresponding to the display angle of view of the right-eye display unit 208 to produce the right-eye display image. Furthermore, displaying the right-eye original image on the external monitor 204 enables the monitoring viewer to also view the fused viewable image whose horizontal display angle of view is 80° and that is viewed by the HMD viewer.

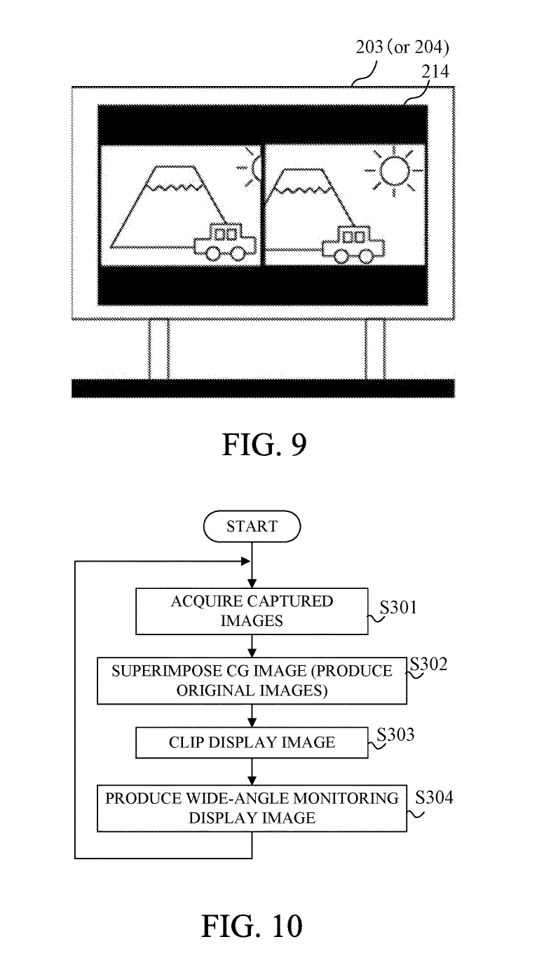

In this embodiment, if only one external monitor is provided, an image to be displayed on the one external monitor may be selected from the images displayed on the external monitors 203 and 204 in the above description. Furthermore, as illustrated in FIG. 9, a monitoring combined display image 214 produced by combining the left-eye and right-eye display images such that these images are arranged in the horizontal direction may be displayed on one external monitor (203 or 204). In this case, in the external monitor an area where no image is displayed may be brought into a black display state or a state where an arbitrary image is displayed. Alternatively, the monitoring combined display image 214 may be scaled so as to correspond to an aspect ratio of the external monitor.

Each of the above embodiments described the case of performing the process for producing the left-eye and right-eye original images by superimposing the CG image on the left-eye and right-eye captured images, the process for producing the left-eye and right-eye display images by clipping the partial areas from the left-eye and right-eye original images, and the process for producing the wide-angle monitoring display image from the original image. That is, each of the above embodiments described the case where the PC board serves as the first and second image producers. However, in a case where, for example, the CG image is not superimposed on each captured image and thereby each captured image is used as the original image, the image inputter/outputter (115 or 215) provided in the HMD (101 or 201) may produce the display image by clipping the partial area from the original image. That is, the image inputter/outputter may serve as the first image producer. In this case, the PC board to which the original image is input from the image inputter/outputter may serve as the second image producer that produces the wide-angle monitoring display image from the original image.

Each of the above embodiments enables, when the image-capturing angle of view of each of the left-eye and right-eye image capturers is wider than the display angle of view of each of the first left-eye and right-eye display images, producing the second display image corresponding to an image whose display angle of view is wider than that of each of the first left-eye and right-eye display images.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-153668, filed on Aug. 4, 2016, which is hereby incorporated by reference herein in its entirety.

What is claimed is:

1. An image display system comprising:
a left-eye image capturer and a right-eye image capturer respectively configured to acquire, by image capturing, a left-eye captured image and a right-eye captured image;
a first image producer configured to (a) produce a first left-eye display image using a left-eye original image that is the left-eye captured image or a left-eye processed image produced by image processing performed on the left-eye captured image, and (b) produce a first right-eye display image using a right-eye original image that is the right-eye captured image or a right-eye processed image produced by the image processing performed on the right-eye captured image; and
a first image display unit configured to allow a left eye and a right eye of a first viewer to view the first left-eye display image and the first right-eye display image,
wherein:
the first image producer is configured to produce the first left-eye display image corresponding to an image of a partial area of the left-eye original image and produce the first right-eye display image corresponding to an image of a partial area of the right-eye original image; and
the system further comprises a second image producer configured to produce, using at least one of the left-eye original image and the right-eye original image, a second display image corresponding to an image of an area including the partial area of the at least one of the left-eye and right-eye original images and being wider than that partial area.

2. An image display system according to claim 1, wherein:
the first left-eye display image and the right-eye display image respectively include both-eye image areas that are viewed overlapped with each other through the left eye and the right eye;
the first left-eye display image includes the both-eye image area and a left-eye image area that is viewed by the left eye; and
the first right-eye display image includes the both-eye image area and a right-eye image area that is viewed by the right eye.

3. An image display system according to claim 2, wherein the second display image includes the both-eye image area, the left-eye image area and the right-eye image area.

4. An image display system according to claim 1, wherein the image processing overlaps the left-eye captured images and the right-eye captured image with another image.

5. An image display system according to claim 1, further comprising:
a second image display unit configured to be viewable by a second viewer different from the first viewer; and
an image outputter configured to cause the second image display unit to display the second display image.

6. An image display system according to claim 5, further comprising a selector configured to select an image to be displayed by the second image display unit from the second display image, the first left-eye display image and the first right-eye display image.

7. An image display system according to claim 5, wherein the second image producer is configured to produce, as the image to be displayed by the second image display unit, a combined display image by combining the first left-eye and right-eye display images with each other.

8. An image display system according to claim 1, further comprising:
an image display apparatus including the left-eye and right-eye image capturers and the first image display unit; and
an image processing apparatus including the second image producer,
wherein the first image display unit is included in one of the image display apparatus and the image processing apparatus.

9. A non-transitory storage medium storing a computer program for causing a computer of an image display system to execute a display process, the image display system comprising: a left-eye image capturer and a right-eye image capturer respectively configured to acquire, by image capturing, a left-eye captured image and a right-eye captured image; and a first image display unit configured to allow a left eye and a right eye of a first viewer to view a first left-eye display image and a first right-eye display image, the display process comprising:
a process for (a) producing the first left-eye display image using a left-eye original image that is the left-eye captured image or a left-eye processed image produced by image processing performed on the left-eye captured image, and (b) producing the first right-eye display image using a right-eye original image that is the right-eye captured image or a right-eye processed image produced by image processing performed on the right-eye captured image, the first left-eye display image corresponding to an image of a partial area of the left-eye original image, the first right-eye display image corresponding to an image of a partial area of the right-eye original image; and
a process for producing, using at least one of the left-eye original image and the right-eye original image, a second display image corresponding to an image of an area including the partial area of the at least one of the left-eye and right-eye original images and being wider than that partial area.
